(19) United States
(12) Patent Application Publication
(10) Pub. No.: US 2015/0303693 A1
(43) Pub. Date: Oct. 22, 2015

(54) POWER CONTROL SYSTEM AND METHOD THEREOF

(71) Applicants: Chien-Chun Wu, Taipei City (TW); Kuan-Chien Chou, Taipei City (TW); Hao-Ying Chang, Taipei City (TW); Hao-Ran Lee, Taipei City (TW)

(72) Inventors: Chien-Chun Wu, Taipei City (TW); Kuan-Chien Chou, Taipei City (TW); Hao-Ying Chang, Taipei City (TW); Hao-Ran Lee, Taipei City (TW)

(73) Assignee: COMPAL ELECTRONICS, INC., Taipei City (TW)

(21) Appl. No.: 14/672,243

(22) Filed: Mar. 30, 2015

Related U.S. Application Data
(60) Provisional application No. 61/981,201, filed on Apr. 18, 2014.

(51) Int. Cl. H02J 3/14

(52) U.S. Cl. CPC H02J 3/14; H02J 2003/143

(57) ABSTRACT

A power controlling system and a method thereof are provided. The power controlling system includes a plurality of connection units, a management server and a user server. Each connection unit has a measuring unit. The measuring units measure power statuses of power provided to a plurality of electrical appliances from an external power to respectively generate power information. The connection units are divided into a plurality of connection unit groups, each of connection unit groups respectively represents power consumption intervals corresponding to the electrical appliances. The management server has a first microcontroller and a database. The database records a first predetermined electricity load value. The first microcontroller receives the power information and compares it with the first predetermined electricity load value to generate a power distribution proposal. The user controller has a control interface, receives the power distribution proposal and displays it to the control interface.

### CROSS-REFERENCE TO RELATED APPLICATION

This application claims the priority benefits of U.S. provisional application Ser. No. 61/981,201, filed on Apr. 18, 2014. The entirety of the above-mentioned patent application is hereby incorporated by reference herein and made a part of this specification.

### BACKGROUND

1. Technical Field

The invention relates to a power supplying technique, and particularly relates to a power control system capable of providing a power distribution proposal in real-time and a method thereof.

2. Related Art

Along with quick development of technology, many electrical products are applied in people's daily life, for example, washing machines, dishwashers, refrigerators and electric pots, etc., and along with development of a home automation control system, various electrical products and computer software technique and application programs are combined to implement smart functions such as remote control, etc., so as to provide a convenient and comfortable family life.

However, although theses electrical products bring conveniences to people's life, a considerable electric power is consumed. Although some home appliances with inbuilt smart functions (for example, a smart refrigerator) have a self automatic power distribution function (for example, have a power-saving mode), such home appliances generally have a high price and only have an individual power-saving effect, and a smart power-saving effect of an overall household electricity cannot be achieved.

### SUMMARY

The invention is directed to a power control system and a method thereof. The power control system can provide a proper power distribution proposal for an overall electricity in a specific region (for example, a family environment), so as to achieve a smart power-saving effect for the overall household electricity.

The invention provides a power control system including a plurality of connection units, a management server and a user controller. Each connection unit has a measuring unit. The connection units measure power statuses of power provided to a plurality of electrical appliances from an external power to respectively generate a plurality of power information. The connection units are divided into a plurality of connection unit groups, each of the connection unit groups respectively represents power consumption intervals corresponding to the electrical appliances. The management server has a first microcontroller and a database. The database records a first predetermined electricity load value. The first microcontroller receives the power information and compares the same with the first predetermined electricity load value to generate a power distribution proposal. The user controller has a control interface, and receives the power distribution proposal and displays the same on the control interface.

According to another aspect, the invention provides a power control method, which is adapted to a power control system having a plurality of connection units. In the method, power statuses of power provided to a plurality of electrical appliances from an external power are measured to respectively generate a plurality of power information. Then, the power information is received and is compared with a first predetermined electricity load value to generate a power distribution proposal. Moreover, the power distribution proposal is received and displayed on a control interface.

According to the above descriptions, the power control system of the invention can pre-classify the connection units (i.e. connection sockets) within a specific region such as a family environment (into the connection unit groups) according to the power consumption intervals, and measure the power statuses of the connection units, so as to provide a proper power distribution proposal according to the power consumption intervals corresponding to each of the connection units. Moreover, through a control interface of the user controller (for example, a notebook, a tablet PC, a smart phone), the user can learn a power status of the family environment in real-time, and accordingly adopts a proper power adjustment, so as to achieve the smart power-saving effect of the overall household electricity.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system schematic diagram of a power control system according to an embodiment of the invention.

FIG. 2 is a schematic diagram of connection unit groups according to an embodiment of the invention.

FIG. 3 is an example of a power control system according to an embodiment of the invention.

FIG. 4 is a functional block diagram of a connection unit according to an embodiment of the invention.

FIG. 5 is a flowchart illustrating a method for controlling a connection unit according to an embodiment of the invention.

FIG. 6 is a flowchart illustrating a method for controlling a connection unit according to an embodiment of the invention.

FIG. 7 is a flowchart illustrating an operation method of a management server according to an embodiment of the invention.

FIG. 8 is an example of control interfaces according to an embodiment of the invention.

FIG. 9 is a flowchart illustrating an operation method of a management server according to an embodiment of the invention.

FIG. 10 is an example of control interfaces according to an embodiment of the invention.

FIG. 11 is a flowchart illustrating a power control method according to an embodiment of the invention.

### DETAILED DESCRIPTION OF DISCLOSED EMBODIMENTS

According to an embodiment of the invention, connection units (i.e. connection sockets) commonly used for supplying an external power to various electrical appliances in a general family are pre-classified according to power consumption intervals. In this way, when the electrical appliances of a specific region are connected to the connection units of different power consumption intervals, power consumption of each electrical appliance can be learned in advance, so as to provide a proper power distribution proposal to achieve a smart power-saving effect for the overall household electricity.

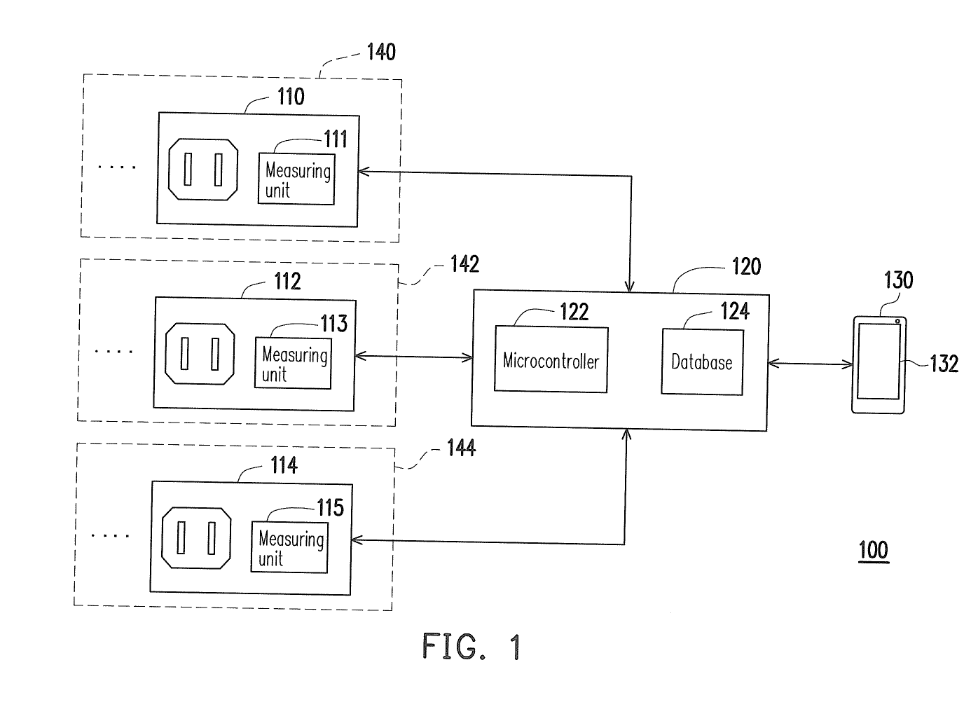

FIG. 1 is a system schematic diagram of a power control system 100 according to an embodiment of the invention. Referring to FIG. 1, in the present embodiment, the power control system 100 includes a plurality of connection units (for example, connection units 110, 112 and 114), a management server 120 and a user controller 130. The connection units 110, 112 and 114 are, for example, connection sockets. The connection units 110, 112 and 114 can respectively provide an external power to a plurality of electrical appliances (for example, air conditioners, electric fans, refrigerators, etc.) connected thereto, such that the electrical appliances can normally operate. In the present embodiment, the connection units 110, 112 and 114 may respectively provide electricity of different electric quantities and are accordingly divided into different connection unit groups (for example, connection unit groups 140, 142 and 144). Namely, the connection unit groups 140, 142 and 144 respectively represent power consumption intervals of the electrical appliances with power supplied by the connection units 110, 112 and 114.

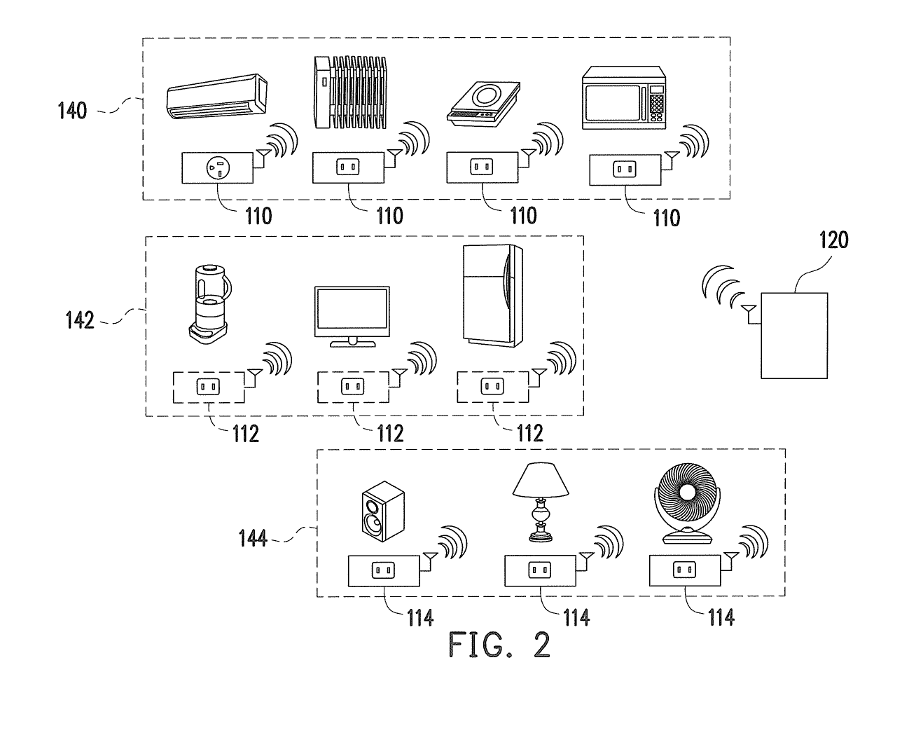

It should be noticed that the connection unit groups (for example, 140, 142 and 144) in FIG. 1 may respectively include a plurality of connection units (for example, 110, 112 and 114). To be specific, FIG. 2 is a schematic diagram of the connection unit groups 140, 142 and 144 according to an embodiment of the invention. Referring to FIG. 2, in FIG. 2, the connection units 110, 112 and 114 in each of the connection unit groups 140, 142 and 144 respectively supply power to different electrical appliances corresponding to different power consumption intervals, and each of the connection units 110, 112 and 114 can establish communication connection with the management server 120 to transmit data. For example, in FIG. 2, the connection unit group 140 where the connection unit 110 belongs to, for example, represents a power consumption interval of 1500 watts to 1000 watts, which is adapted to high power consumption electric appliances such as air conditioners, microwave ovens, etc. The connection unit group 142 where the connection unit 112 belongs to, for example, represents a power consumption interval of 1000 watts to 500 watts, which is adapted to moderate power consumption electric appliances such as televisions, refrigerators, etc. The connection unit group 144 where the connection unit 114 belongs to, for example, represents a power consumption interval below 500 watts, which is adapted to low power consumption electric appliances such as audio equipment, electric fans, etc. Moreover, in FIG. 2, the connection units 110, 112 and 114 of each of the connection unit groups 140, 142 and 144 may have different identification marks according to the power consumption intervals thereof. The identification marks are, for example, housing colors (for example, red, yellow, green), appliance symbol marks or text marks, etc., which is not limited by the invention.

Referring to FIG. 1, in FIG. 1, the connection units 110, 112 and 114 respectively have measuring units 111, 113 and 115. The measuring units 111, 113 and 115 can measure power statuses of power provided to the electrical appliances from an external power to respectively generate a plurality of power information. The power information, for example, includes a connection status between each of the connection units 110, 112, 114 and the corresponding electric appliance, the power consumption interval of each of the connection unit groups 140, 142 and 144 where the connection units 110, 112 and 114 belong to, and power consumption of the electric appliance corresponding to each of the connection units 110, 112 and 114. The external power is, for example, an alternating current (AC) power supplied to general families, though the invention is not limited thereto.

In FIG. 1, the management server 120 is, for example, a computer device capable of establishing a wired communication connection or a wireless communication connection with the connection units 110, 112 and 114. As shown in FIG. 1, the management server 120 has a microcontroller 122 and a database 124. The microcontroller 122 is, for example, a programmable general purpose or special purpose microprocessor, a digital signal processor (DSP), a programmable controller, etc. The database 124 can be a memory device such as a random access memory (RAM), a read-only memory (ROM), a flash memory of any type, or a combination of the similar elements. The database 124 records a regional predetermined electricity load value (a first predetermined electricity load value). To be specific, the regional predetermined electricity load value is a load power consumption of a specific region (for example, a family environment) within a safety range or a predetermined limitation that is obtained through detection, statistic and analysis. The microcontroller 122 receives the power information provided by the measuring units 111, 113 and 115, and accordingly determines a connection status between of each of the connection units 110, 112, 114 and the corresponding electric appliance, the power consumption intervals of each of the connection unit groups 140, 142 and 144 where the connection units 110, 112 and 114 belong to, and power consumptions of the electric appliances. In this way, the microcontroller 122 can determine a current power distribution status (including a total power consumption), and compares the same with the regional predetermined electricity load value in the database 124 to generate a proper power distribution proposal. For example, the microcontroller 122 subtracts the regional predetermined electricity load value by the current total power consumption to calculate an available power, and generates the corresponding power distribution proposal (for example, a proposal of applicable connection unit groups, etc.) for transmitting to the user controller 130 according to the power consumption intervals of the connection unit groups 140, 142 and 144. It should be noticed that in the present embodiment, although the database 124 combined to the management server 120 is taken as an example for description, the invention is not limited thereto. In other embodiments, the database 124 can be a cloud database, and the management server 120 can obtain the required data through a network.

In FIG. 1, the user controller 130 is, for example, a personal electronic product capable of establishing a wired/wireless communication connection with the management server 120, such as a smart phone, a personal digital assistant (PDA), or a navigation device, etc. The user controller 130 has a control interface 132. The user controller 130 receives the power distribution proposal provided by the management server 120 according to the power consumption at that moment and displays the same on the control interface 132. Moreover, the user controller 130 can also display the identification mark (corresponding to the connection unit group) of the connection unit complied with the available power. In this way, the user can learn a power consumption situation of the family environment in real-time, and implement a proper power adjustment, so as to achieve a smart power-saving effect of the overall household electricity.

Moreover, the connection units 110, 112 and 114 of the present embodiment can also be combined with an environment sensing function such as smoke detection, carbon monoxide detection, gas detection, object detection, etc. to provide a home security monitoring function of family.

In order to describe the invention in detail, various implementations of the power distribution proposal are described below with reference of various components of the power control signal 100.

Referring to FIG. 1, in an embodiment, when the microcontroller 122 determines that the total power consumption represented by the power information exceeds the regional predetermined electricity load value, the microcontroller 122 generates the corresponding power distribution proposal to the user controller 130, so as to display a warning message on the control interface 132. For example, it is assumed that the regional predetermined electricity load value is 2500 watts, according to the power information provided by the measuring units 111, 113 and 115, the microcontroller 122 can learn that the connection units 110 and 112 in the connection unit group 140 (with the power consumption interval of 1500 watts to 1000 watts) and the connection unit group 142 (with the power consumption interval of 1000 watts to 500 watts) are respectively connected to currently used electrical appliances and have a total power consumption with an upper limit of 2500 watts (1500+1000 watts). Now, when the user connects another electrical appliance to the connection unit 114 in the connection unit group 144 (with the power consumption interval below 500 watts), according to the real-time power information obtained by the connection units 110, 112 and 114, the microcontroller 122 determines that the upper limit of the total power consumption reaches 3000 watts (1500+1000+500 watts) when the user turns on the electrical appliance connected to the connection unit 114, which is greater than the regional predetermined electricity load value (2500 watts). Therefore, the microcontroller 122 can transmit a power distribution proposal of, for example, not to turn on or unplug the electrical appliance connected to the connection unit 114 to the user controller 130, so as to display a warning message on the control interface 132 in collaboration with the identification mark (for example, a green socket) of the connection unit 114. The control interface 132, for example, displays the warning message in text in collaboration with any acousto-optic effect, though the invention is not limited thereto.

In an embodiment, corresponding to the power distribution proposal that the total power consumption exceeds the regional predetermined electricity load value, besides the warning message, a mode adjustment instruction message or a turn-off priority instruction message for each of the currently used electrical appliances is also included. For example, in FIG. 1, when the connection units (for example, 110, 112 and 114) are connected to the electrical appliances and a sum of the upper limits of the power consumption intervals exceeds the regional predetermined electricity load value, the microcontroller 122 can provide a power distribution proposal of mode adjustment for the electrical appliances connected to the connection unit 110, 112 and 114 according to the obtained real-time power information, for example, a proposal of adjusting an air conditioner or an electric fan from a strong wind mode to a mode with less power consumption such as a weak wind mode, etc., and controls to display corresponding mode adjustment instruction messages on the display interface 132 in collaboration with the identification marks of the connection units 110, 112 and 114. Alternatively, the microcontroller 122 determines significances of the electrical appliances by pre-estimating the number of uses and usage timing of the electrical appliances or a user setting, and provides a power distribution proposal of a turn-off sequence according to the significances of the electrical appliances, for example, a proposal of turning off the unused air conditioner in case of the winter, and controls to display a corresponding a turn-off priority instruction message on the display interface 132 in collaboration with the identification marks of the connection units 110, 112 and 114. In this way, a proper proposal of reducing power consumption is provided to the user, so as to avoid overload of the household electricity.

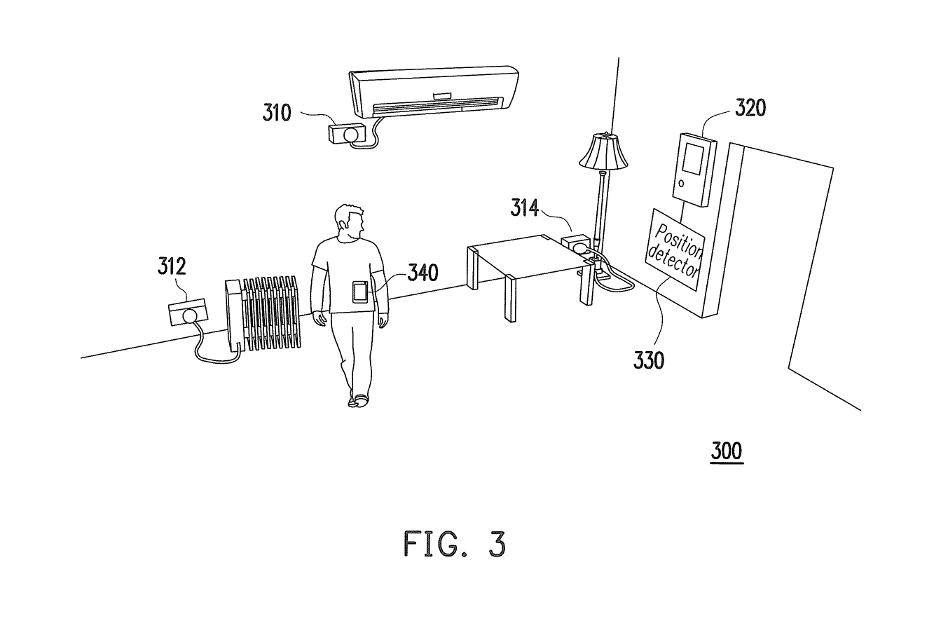

In an embodiment, the power control system may further include a position detector, and takes position information of the user into consideration. For example, FIG. 3 is an example of a power control system 300 according to an embodiment of the invention. Referring to FIG. 3, in the present embodiment, the power control system 300 includes connection units 310, 312 and 314, a management server 320, a position detector 330 and a user controller 340. The position detector 330 can be coupled to the management server 320 through a wired or wireless manner. The position detector 330 is, for example, a circuit or an element capable of sensing a position of the user, such as a near-field sensor, a light sensor or an infrared sensor, etc. Functions of the other components are the same or similar to the corresponding components of the aforementioned embodiment, and details thereof are not repeated.

In FIG. 3, the position detector 330 can detect the position of the user to provide position information. The management server 320 generates a power distribution proposal according to the position information, power information come from the connection units 310, 312 and 314 and the regional predetermined electricity load value in a range (room) of FIG. 3. For example, when the management server 320 determines that the total power consumption represented by the power information exceeds the regional predetermined electricity load value, the management server 320 can transmit a proper power distribution proposal, for example, a proposal of turning off the electrical appliances located far away from the user or the electrical appliances in other rooms to the user controller 340 according to the position information of the user, so as to display a corresponding message on the control interface. Moreover, in some embodiments, the management server 320 can obtain the position information of the user through a positioning system (for example, a global positioning system) in the user controller 340 according to a habit that the user usually carries the user controller 340 around, so as to generate the corresponding power distribution proposal.

In an embodiment, besides that the user unplugs the electrical appliances or adjusts a usage mode of the electrical appliances according to the power distribution proposal, the connection units can be controlled to stop supplying power through the management server, so as to achieve the power-saving effect.

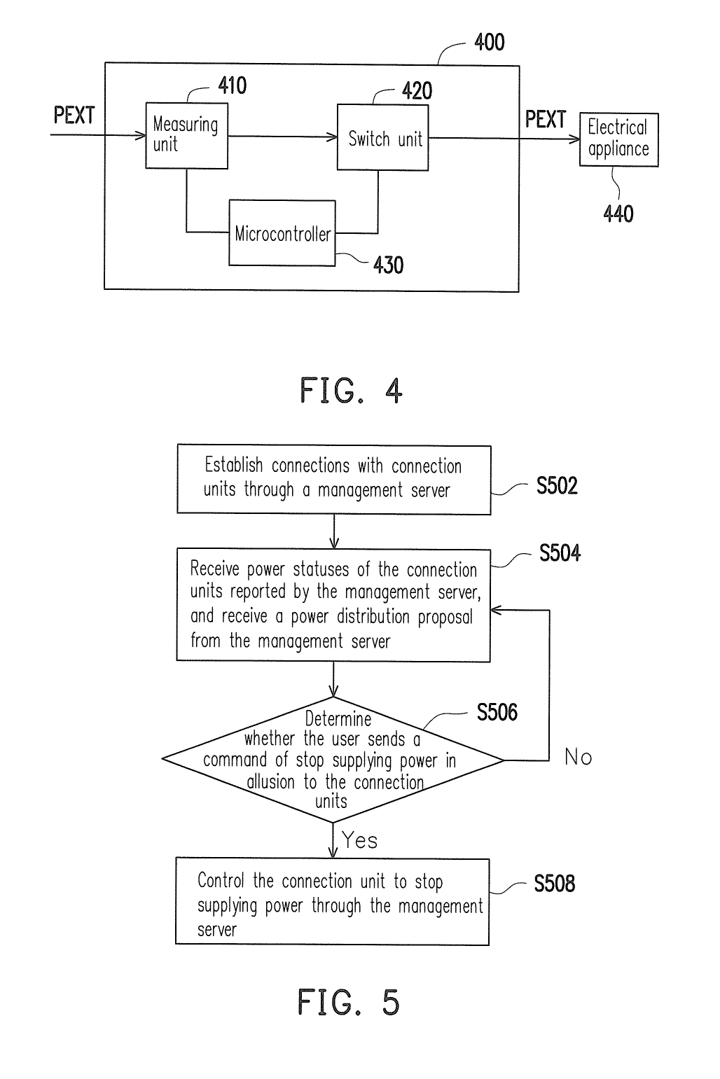

FIG. 4 is a functional block diagram of a connection unit 400 according to an embodiment of the invention. Referring to FIG. 4, in the present embodiment, the connection unit 400 includes a measuring unit 410, a switch unit 420 and a microcontroller 430. In FIG. 4, the microcontroller 430 is coupled to the measuring unit 410 and the switch unit 420. The connection unit 400 receives an external power PEXT and provides the same to an electrical appliance 440 connected thereto through the measuring unit 410 and the switch unit 420. The microcontroller 430 can establish a connection with an external management server, and when the management server receives an instruction from the user to stop supplying power, the microcontroller 430 can receive the instruction sent by the management server and control the switch unit 420 to stop supplying power through the connection unit 400.

Moreover, when the power information generated by the measuring unit 410 represents that a quantity of power supplied to the electric appliance 440 exceeds a predetermined electricity load value (a second predetermined electricity load value) of a single connection unit, the microcontroller 430 can actively control the switch unit 420 to stop supplying power through the connection unit 400, so as to avoid excessive load of the connection unit 400 to cause a damage.

FIG. 5 is a flowchart illustrating a method for controlling a connection unit according to an embodiment of the invention. Referring to FIG. 1 and FIG. 5, the method for controlling the connection unit of the present embodiment is adapted to the power control system 100 of FIG. 1, and various steps of the method for controlling the connection unit of the invention are described below with reference of various components of the power control system 100.

In step S502, the user controller 130 establishes connections with the connection units 110, 112 and 114 through the management server 120. In step S504, the user controller 130 receives power statuses of the connection units 110, 112 and 114 reported by the management server 120, and receives a power distribution proposal from the management server 120. In step S506, the user controller 130 displays the obtained power statuses and the power distribution proposal on the control interface 132, and determines whether the user sends a command of stop supplying power in allusion to the connection units 110, 112 and 114. When the user controller 130 receives the command of stop supplying power from the user in allusion to the connection unit 110, 112 and 114, in step S508, the user controller 130 controls the connection unit 110, 112 and 114 to stop supplying power through the management server 120. When the user controller 130 does not receive the command of stop supplying power sent in allusion to the connection units 110, 112 and 114, the flow returns to the step S504, and the management server 120 continually reports the power statuses of the connection units 110, 112 and 114.

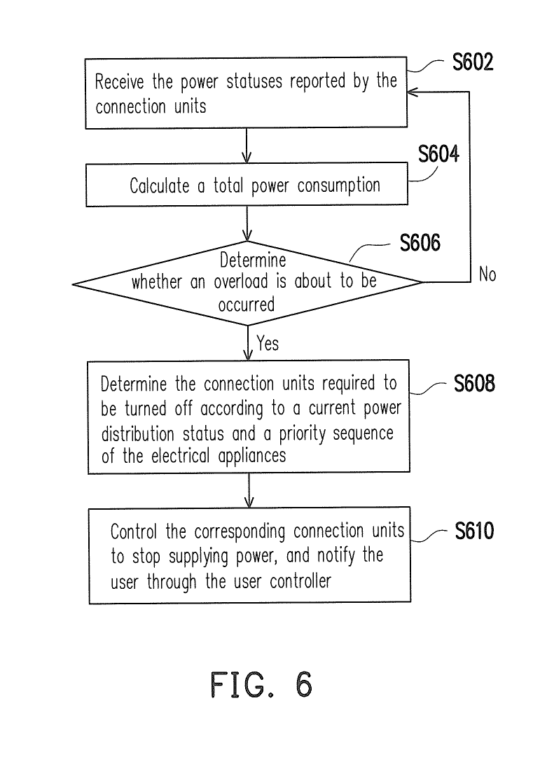

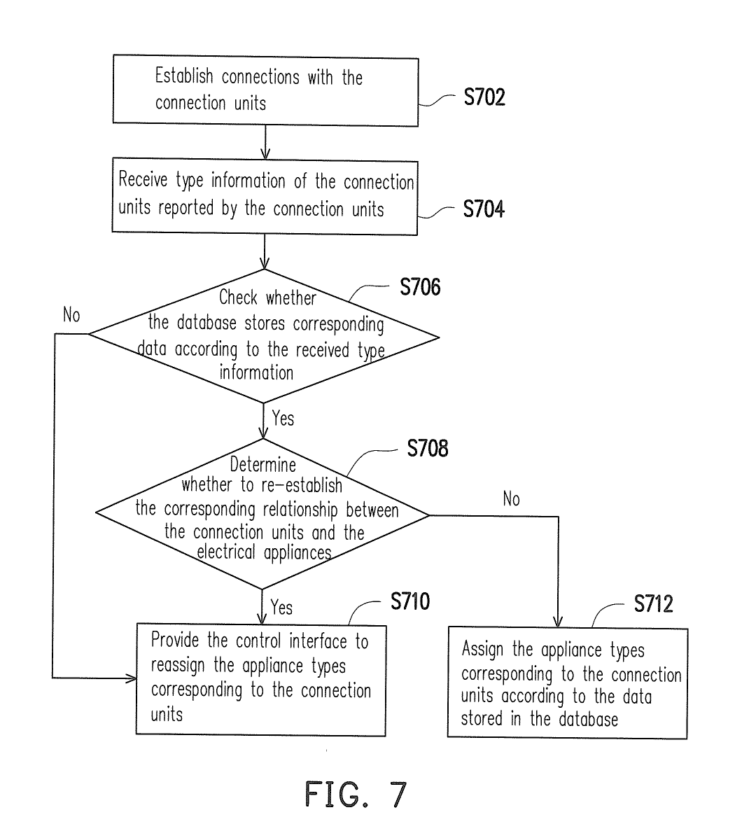

In an embodiment, the management server can automatically control the connection units to stop supplying power according to the power statuses of the connection units. FIG. 6 is a flowchart illustrating a method for controlling a connection unit according to an embodiment of the invention. Referring to FIG. 1 and FIG. 6, the method for controlling the connection unit of the present embodiment is adapted to the power control system 100 of FIG. 1, and various steps of the method for controlling the connection unit of the invention are described below with reference of various components of the power control system 100.

In step S602, the management server 120 receives the power statuses reported by the connection units 110, 112 and 114. In step S604, the management server 120 calculates a total power consumption. To be specific, the management server 120 can calculate a global total power consumption of a specific region (for example, a family environment) or a regional total power consumption of a part of the connection unit groups according to an actual requirement. Moreover, in step S606, the management server 120 can compare the total power consumption with data in the database 124 to determine whether an overload is about to be occurred. When the management server 120 determines that the overload is about to be occurred, in step S608, the management server 120 determines the connection units required to be turned off according to a current power distribution status and a priority sequence of the electrical appliances. Moreover, in step S610, the management server 120 controls the corresponding connection units to stop supplying power, and notifies the user a power-off status of the connection units through the user controller 130. Moreover, when the management server 120 determines that the overload is not occurred, in step S602, the management server 120 continually receives the reported power statuses of the connection units 110, 112 and 114.

In an embodiment, the management server can also establish a corresponding relationship between the connection unit groups where the connection units belong to and the electric appliances in the database. FIG. 7 is a flowchart illustrating an operation method of a management server according to an embodiment of the invention. Referring to FIG. 1 and FIG. 7, the operation method of the management server of the present embodiment is adapted to the power control system 100 of FIG. 1, and various steps of the operation method of the management server of the invention are described below with reference of various components of the power control system 100.

In step S702, the management server 120 establishes connections with the connection units 110, 112 and 114. In step S704, the management server 120 receives type information of the connection units 110, 112 and 114 reported by the connection units 110, 112 and 114. In step S706, the management server 120 checks whether the database 124 stores corresponding data according to the received type information. When the database 124 stores the corresponding data, in step S708, the management server 120 determines whether to re-establish the corresponding relationship between the connection units 110, 112 and 114 and the electrical appliances. When the corresponding relationship between the connection units 110, 112 and 114 and the electrical appliances is required to be re-established or the database 124 does not store the corresponding data, in step S710, the management server 120 controls the user controller 130 to provide the control interface 132 to reassign the appliance types corresponding to the connection units 110, 112 and 114.

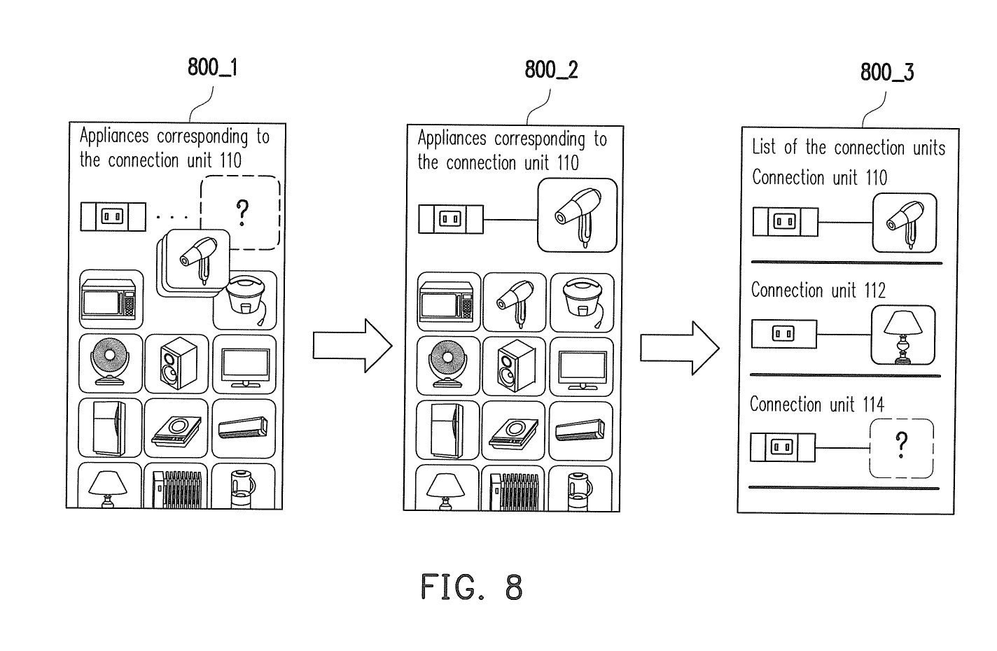

For example, FIG. 8 is an example of the control interfaces according to an embodiment of the invention. In FIG. 8, shown as the control interfaces 800_1-800_3, the user can click and select the appliance types for example, fans, lamps, etc., corresponding to the connection units 110, 112 and 114.

Referring back to FIG. 7, after the step S708, when the corresponding relationship between the connection units 110, 112 and 114 and the electrical appliances is not re-established, in step S712, the management server 120 can assign the appliance types corresponding to the connection units 110, 112 and 114 according to the data stored in the database 124.

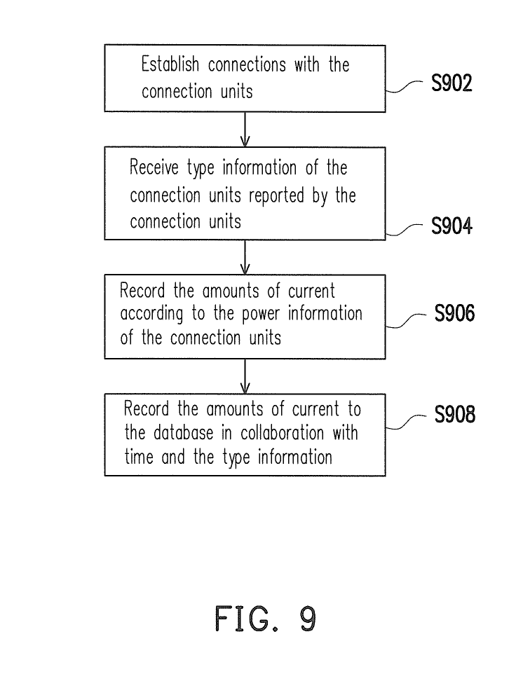

In an embodiment, the management server can also record a relationship between the type information of the connection unit and amounts of current, etc. FIG. 9 is a flowchart illustrating an operation method of a management server according to an embodiment of the invention. Referring to FIG. 1 and FIG. 9, the operation method of the management server of the present embodiment is adapted to the power control system 100 of FIG. 1, and various steps of the operation method of the management server of the invention are described below with reference of various components of the power control system 100.

In step S902, the management server 120 establishes connections with the connection units 110, 112 and 114. In step S904, the management server 120 receives type information of the connection units 110, 112 and 114 reported by the connection units 110, 112 and 114. In step S906, the management server 120 records the amounts of current of the connection units 110, 112 and 114 according to the power information of the connection units 110, 112 and 114. In step S908, the management server 120 records the amounts of current to the database 124 in collaboration with time and the type information of the connection units 110, 112 and 114.

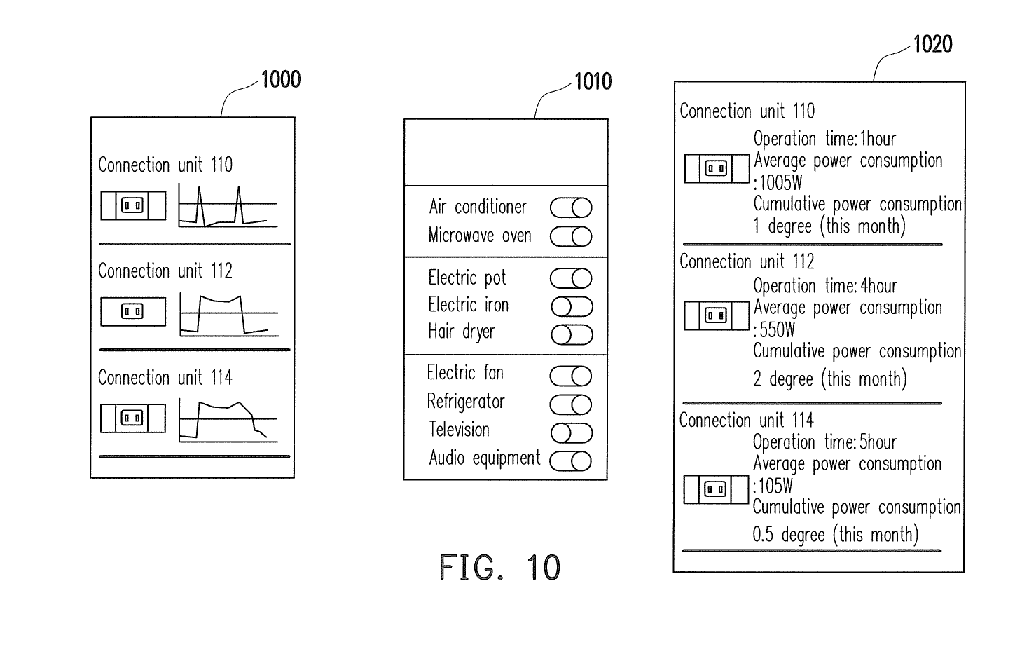

Moreover, in an embodiment, the management server 120 can also display various power statuses of the connection units 110, 112 and 114 on the control interface 132 of the user controller 130. For example, FIG. 10 is an example of control interfaces according to an embodiment of the invention. In FIG. 10, the control interface 1000 displaces various power statuses of the connection units 110, 112 and 114.

Moreover, the control interface 132 can also display on-off states of the electrical appliances connected to the connection units 110, 112 and 114 or monthly electricity expenses (as shown in control interfaces 1010 and 1020), though the invention is not limited thereto.

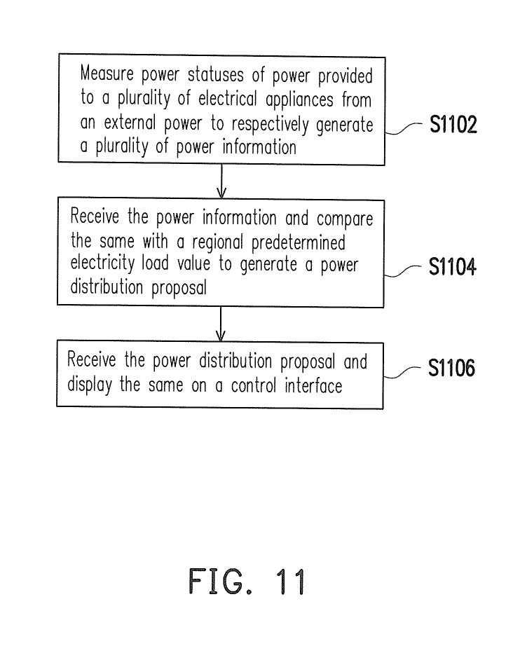

The invention also provides a power control method. FIG. 11 is a flowchart illustrating a power control method according to an embodiment of the invention. Referring to FIG. 11, the power control method of the present embodiment includes following steps. Power statuses of power provided to a plurality of electrical appliances from an external power are measured to respectively generate a plurality of power information (step S1102). Then, the power information is received and is compared with a regional predetermined electricity load value to generate a power distribution proposal (step S1104). Moreover, the power distribution proposal is received and displayed on a control interface (step S1106). Details of the aforementioned steps S1102, S1104 and S1106 may refer to the embodiments of FIG. 1 to FIG. 10, which are not repeated.

In summary, the power control system of the invention can pre-classify the connection units (i.e. connection sockets) within a specific region (into the connection unit groups) according to the power consumption intervals, so as to provide a proper power distribution proposal to the user according to the power statuses of the connection units and the corresponding power consumption intervals. In this way, the user can learn a power status of the family environment in real-time without applying a high cost design, and can adopt proper power adjustments to achieve the smart power-saving effect of the overall household electricity.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A power control system, comprising:
a plurality of connection units, each connection unit having a measuring unit, the connection units measuring power statuses of power provided to a plurality of electrical appliances from an external power to respectively generate a plurality of power information, wherein the connection units are divided into a plurality of connection unit groups, and each of the connection unit groups respectively represents power consumption intervals corresponding to the electrical appliances;
a management server, having a first microcontroller and a database, wherein the database records a first predetermined electricity load value, and the first microcontroller receives the power information and compares the same with the first predetermined electricity load value to generate a power distribution proposal; and
a user controller, having a control interface, and receiving the power distribution proposal and displaying the same on the control interface.

2. The power control system as claimed in claim 1, wherein when the first microcontroller determines that a total power consumption represented by the power information exceeds the first predetermined electricity load value, the first microcontroller generates the corresponding power distribution proposal to the user controller, so as to display a warning message on the control interface.

3. The power control system as claimed in claim 2, wherein the generated power distribution proposal comprises a mode adjustment instruction message or a turn-off priority instruction message for the electrical appliances.

4. The power control system as claimed in claim 1, further comprising:
a position detector, coupled to the management server, and detecting a user position to provide position information, wherein the first microcontroller generates the power distribution proposal according to the position information, the power information and the first predetermined electricity load value.

5. The power control system as claimed in claim 1, wherein each of the connection units has a different identification mark according to the provided power consumption interval.

6. The power control system as claimed in claim 5, wherein the first microcontroller subtracts the first predetermined electricity load value by a total power consumption represented by the power information to calculate an available power, and generates the corresponding power distribution proposal to the user controller, so as to display the identification marks of the connection units complied with the available power on the control interface.

7. The power control system as claimed in claim 1, wherein the connection unit further comprises a second microcontroller and a switch unit, the second microcontroller is coupled to the measuring unit and the switch unit, and when the power information generated by the measuring unit represents that a quantity of power supplied to the corresponding electrical appliance exceeds a second predetermined electricity load value, the second microcontroller controls the switch unit to stop supplying power through the connection unit.

8. A power control method, adapted to a power control system having a plurality of connection units, the power control method comprising:
measuring power statuses of power provided to a plurality of electrical appliances from an external power to respectively generate a plurality of power information;
receiving the power information and comparing the same with a first predetermined electricity load value to generate a power distribution proposal; and
receiving the power distribution proposal and displaying the same on a control interface.

9. The power control method as claimed in claim 8, wherein after the step of receiving the power information and comparing the same with the first predetermined electricity load value, the power control method further comprises:
determining whether a total power consumption represented by the power information exceeds the first predetermined electricity load value; and
generating the corresponding power distribution proposal when the total power consumption exceeds the first predetermined electricity load value, so as to display a warning message on the control interface.

10. The power control method as claimed in claim 9, wherein the generated power distribution proposal comprises a mode adjustment instruction message or a turn-off priority instruction message for the electrical appliances.

11. The power control method as claimed in claim 8, wherein after the step of respectively generating the power information, the power control method further comprises:
detecting a user position to provide position information; and
generating the power distribution proposal according to the position information, the power information and the first predetermined electricity load value.

12. The power control method as claimed in claim 8, wherein each of the connection units has a different identification mark according to the provided power consumption interval.

13. The power control method as claimed in claim 12, wherein after the step of receiving the power information and comparing the same with the first predetermined electricity load value, the power control method further comprises:
subtracting the first predetermined electricity load value by a total power consumption represented by the power information to calculate an available power; and
generating the corresponding power distribution proposal, so as to display the identification marks of the connection units complied with the available power on the control interface.

14. The power control method as claimed in claim 8, wherein after the step of respectively generating the power information, the power control method further comprises:
determining whether a quantity of power supplied to the corresponding electrical appliance exceeds a second predetermined electricity load value according to the power information; and
controlling the connection unit to stop supplying power when the quantity of power of the connection unit exceeds the second predetermined electricity load value.
